(19) United States
(12) Patent Application Publication
(10) Pub. No.: US 2025/0076138 A1
(43) Pub. Date: Mar. 6, 2025

(54) PRESSURE DETECTION MODULE AND PRESSURE SENSOR

(71) Applicant: Measurement Specialties (China) Ltd., Shenzhen City (CN)

(72) Inventors: Pengcheng Feng, Shenzhen (CN); Jianhai (Ross) Qiu, Shenzhen (CN); Xuetang Zhao, Shenzhen (CN)

(73) Assignee: Measurement Specialties (China) Ltd., Shenzhen City (CN)

(21) Appl. No.: 18/818,958

(22) Filed: Aug. 29, 2024

(30) Foreign Application Priority Data
Sep. 1, 2023 (CN) 202311138678.1

(51) Int. Cl. G01L 7/18

(52) U.S. Cl. CPC G01L 7/185; G01L 7/182

(57) ABSTRACT

A pressure detection module includes a pressure joint. A force sensitive component of the module is connected to one end of the pressure joint. A strain gauge in attached to a surface of the force sensitive component. An electrical connector of the module has a seat and a pin that passes therethrough. An electrical connection board electrically connects the pin to the strain gauge. An end cap of the module includes a peripheral wall, an end wall, and an opening opposite to the end wall, the force sensitive component and the electrical connection board are accommodated in an inner cavity thereof. One end of the pressure joint is welded to the open end of the end cap. A socket is formed in the end wall of the end cap, and the seat is inserted into the socket and welded to the end wall.

### CROSS-REFERENCE TO RELATED APPLICATION

This application claims the benefit of Chinese Patent Application No. CN202311138678.1 filed on Sep. 1, 2023 in the State Intellectual Property Office of China, the whole disclosure of which is incorporated herein by reference.

### FIELD OF THE DISCLOSURE

The present disclosure relates to a pressure detection module and a pressure sensor comprising the pressure detection module.

### BACKGROUND OF THE INVENTION

In the prior art, an absolute pressure sensor typically includes an oil filled pressure sensor and a strain gauge pressure sensor. The cost of the oil filled pressure sensor is relatively high and there is a risk of oil leakage. The strain gauge pressure sensor requires its strain gauges to be sealed in a closed space. The sealing scheme of existing strain gauge pressure sensor is relatively complex, low in reliability, and high in cost.

### SUMMARY OF THE INVENTION

According to an embodiment of the present disclosure, a pressure detection module includes a pressure joint. A force sensitive component of the module is connected to one end of the pressure joint. A strain gauge in attached to a surface of the force sensitive component. An electrical connector of the module has a seat and a pin that passes therethrough. An electrical connection board electrically connects the pin to the strain gauge. An end cap of the module includes a peripheral wall, an end wall, and an opening opposite to the end wall, the force sensitive component and the electrical connection board are accommodated in an inner cavity thereof. One end of the pressure joint is welded to an open end of the end cap. A socket is formed in the end wall of the end cap, and the seat is inserted into the socket and welded to the end wall.

### BRIEF DESCRIPTION OF DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows a three-dimensional sectional view of a pressure detection module according to an exemplary embodiment of the present invention;

FIG. 2 shows an illustrative exploded view of a pressure detection module according to an exemplary embodiment of the present invention;

FIG. 3 shows an illustrative perspective view of the end cap portion of a pressure detection module according to an exemplary embodiment of the present invention;

FIG. 4 shows an illustrative exploded view of the end cap portion of the pressure detection module according to an exemplary embodiment of the present invention; and

FIG. 5 shows an illustrative perspective view of a pressure sensor according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to one embodiment of the present disclosure, a pressure detection module is provided. The pressure detection module includes: a pressure joint adapted to connect to a detected pipeline and having a fluid path for fluid communication with the detected pipeline; a force sensitive component connected to one end of the pressure joint and in fluid communication with the pressure joint; at least one strain gauge attached to the surface of the force sensitive component for detecting strain of the force sensitive component; an electrical connector having a seat and a pin that passes through and is fixed to the seat; an electrical connection board electrically connecting the pin to the strain gauge; and an end cap including a peripheral wall, an end wall, and an opening opposite to the end wall. The force sensitive component and the electrical connection board are accommodated in an inner cavity of the end cap. One end of the pressure joint is welded to an open end of the end cap to seal the opening of the end cap. A socket is formed in the end wall of the end cap. The seat is inserted into the socket and welded to the end wall to seal the socket of the end cap.

According to another embodiment of the present disclosure, a pressure sensor is provided. The pressure sensor includes a housing, and the above pressure detection module partially installed in the housing. The end cap and one end of the pressure joint are accommodated in the housing. The other end of the pressure joint is located outside the housing for connecting to the detected pipeline.

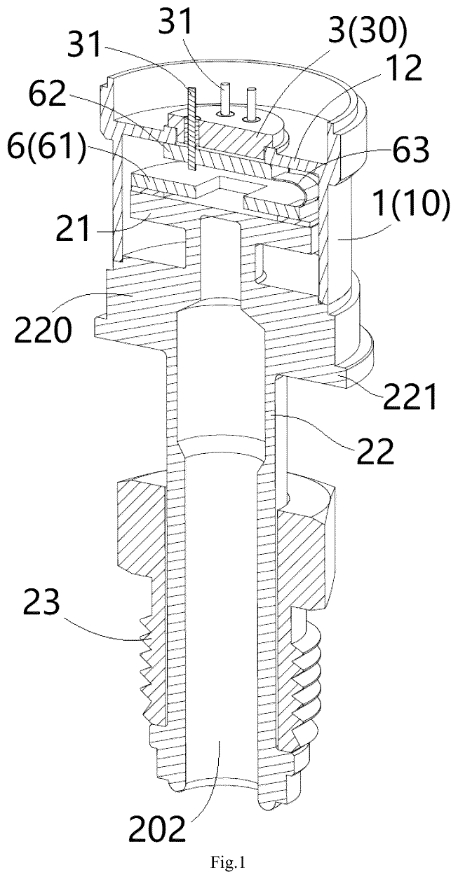

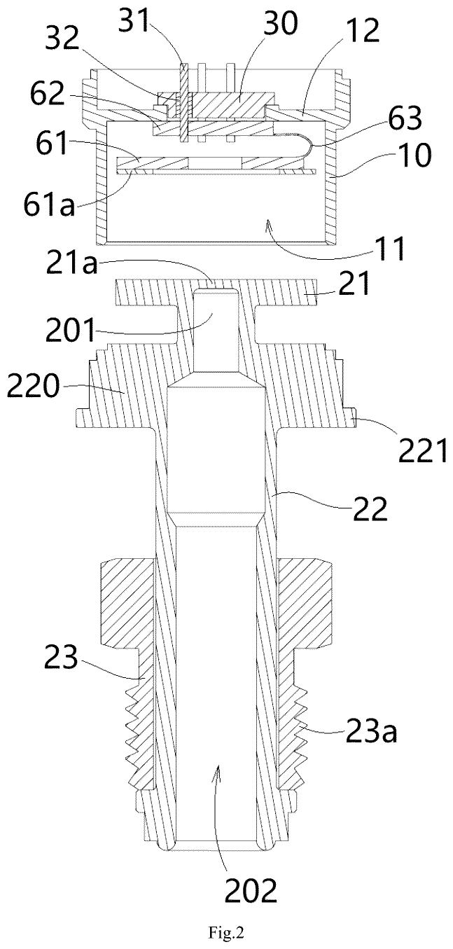

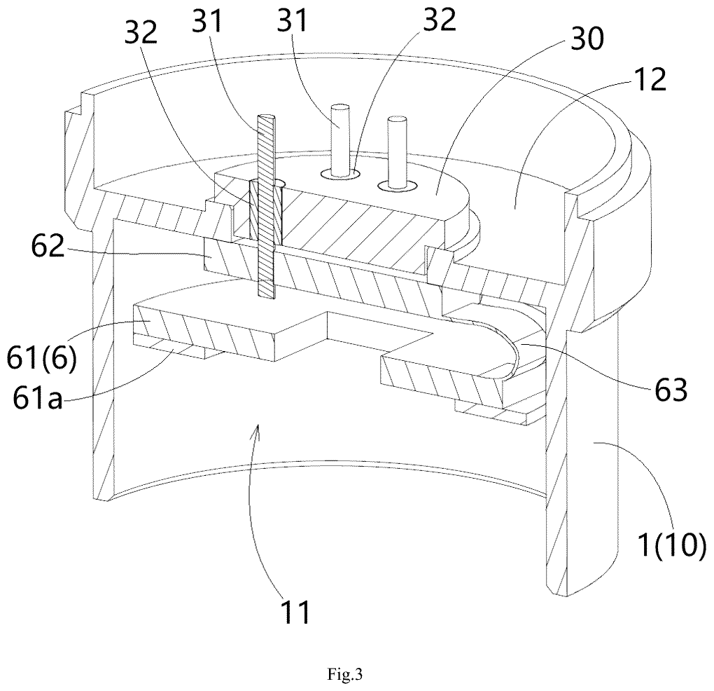

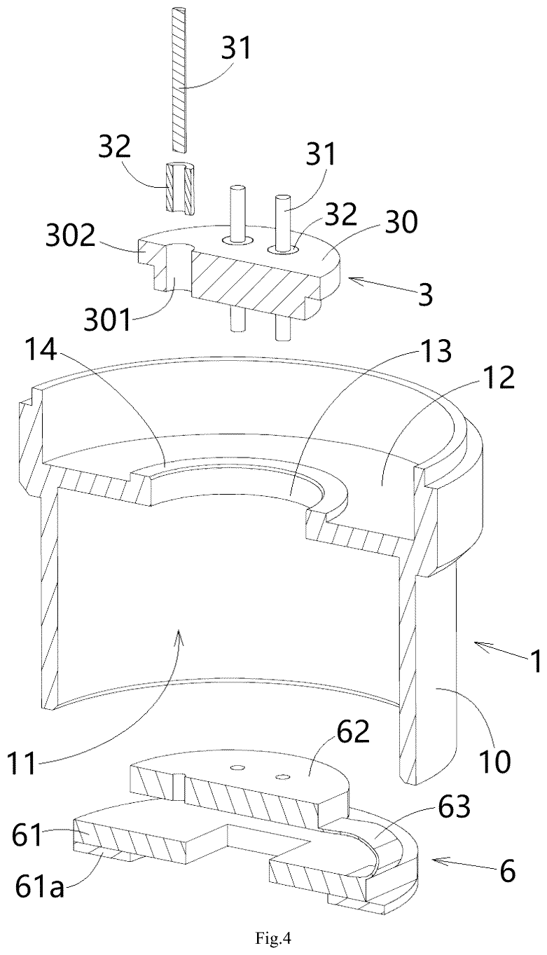

FIG. 1 shows a three-dimensional sectional view of a pressure detection module according to an exemplary embodiment of the present disclosure. FIG. 2 shows an illustrative exploded view of a pressure detection module according to an exemplary embodiment of the present disclosure. FIG. 3 shows an illustrative perspective view of the end cap portion of a pressure detection module according to an exemplary embodiment of the present disclosure. FIG. 4 shows an illustrative exploded view of the end cap portion of the pressure detection module according to an exemplary embodiment of the present disclosure.

As shown in FIGS. 1 to 4, in an exemplary embodiment of the present disclosure, a pressure detection module is provided. The pressure detection module includes: a pressure joint 22; a force sensitive component 21; strain gauges; an electrical connector 3; an electrical connection board 6; and an end cap 1. The pressure joint 22 is used to connect to the customer's detected pipeline and has a fluid path 202 for fluid communication with the detected pipeline. The force sensitive component 21 is connected to one end 220 of the pressure joint 22 and is in fluid communication with the pressure joint 22. Strain gauges are attached to the surface of the force sensitive component 21 to detect the strain (i.e. elastic deformation) of the force sensitive component 21. The electrical connector 3 includes a seat 30 and a pin 31 that passes through and is fixed to the seat 30. The electrical connection board 6 is used to connect the pin 31 to the strain gauge. The end cap 1 includes a peripheral wall 10, an end wall 12, and an opening 11 opposite to the end wall 12.

In the illustrated embodiments, the force sensitive component 21 and the electrical connection board 6 are accommodated in the inner cavity of the end cap 1, and one end 220 of the pressure joint 22 is welded to the open end of the end cap 1 to seal the opening 11 of the end cap 1. A socket 13 is formed in the end wall 12 of the end cap 1, and the seat 30 is inserted into the socket 13 and welded to the end wall 12 to seal the socket 13 of the end cap 1.

The opening 11 and the socket 13 of the end cap 1 are sealed by the pressure joint 22 and the electrical connector 3, respectively, so that the force sensitive component 21 and the strain gauges are both sealed in the inner cavity of the end cap 1. Moreover, the sealing structure of the present invention is simple, the sealing reliability is high, and the cost is low.

The end cap 1 is welded to the end 220 of the pressure joint 22 instead of being directly welded to the force sensitive component 21, thereby avoiding adverse effects on the force sensitive component 21 and improving pressure detection accuracy.

A through-hole 301 is formed in the seat 30 that allows the pin 31 to pass through. The pin 31 passes through the through-hole 301 and is bonded to the seat 30 through a glass encapsulation process, so that the outer peripheral surface of the pin 31 and the inner peripheral surface of the through-hole 301 are tightly bonded together by sintered glass 32.

The seat 30 and the pin 31 are made of the same metal material or of metal materials with the same or similar coefficient of thermal expansion. The thermal expansion coefficient of the seat 30 and the pin 31 is the same or similar to that of the glass 32. In this way, it can effectively prevent gaps between the seat 30 and the pin 31 during thermal expansion and contraction, improving the sealing reliability between the seat 30 and the pin 31.

The seat 30 and the pin 31 may be made of Kovar alloy. This is because the thermal expansion coefficient of Kovar alloy is very close to that of glass 32. However, the present invention is not limited to the illustrated embodiments, and the seat 30 and pin 31 can also be made of other suitable metal materials.

A coating is electroplated on the exposed surfaces of the seat 30 and the pin 31. When electroplating the coating, the electrical connector 3 is completely immersed in the electroplating solution to form a coating on the exposed surfaces of the seat 30 and the pin 31 simultaneously. Therefore, the present invention does not require separate electroplating of multiple pins 31 and the seat 30, simplifying the electroplating process.

An annular protrusion 14 surrounding the socket 13 is formed on the outer side of the end wall 12 of the end cap 1, and an annular flange 302 is formed on the outer peripheral surface of the seat 30. The annular flange 302 of the seat 30 is axially pressed against the top surface of the annular protrusion 14 of the end cap 1 and welded to the top surface of the annular protrusion 14 to seal the socket 13 of the end cap 1.

The electrical connection board 6 comprises: a first rigid connection board 61; a second rigid connection board 62; and a flexible connection board 63. The first rigid connection board 61 is attached to the outer surface of the force sensitive component 21 and electrically connected to the strain gauges. The second rigid connection board 62 is electrically connected to the pins 31 of the electrical connector 3. The flexible connection board 63 is electrically connected between the first rigid connection board 61 and the second rigid connection board 62. In the illustrated embodiment, due to the flexibility of the flexible connection board 63, no stress is applied on the pins 31, so that the pins 31 do not move relative to the seat 30, thereby not damaging the seal between the pins 31 and the seat 30 of the electrical connector 3, improving the sealing reliability.

The first rigid connection board 61 is adhered to the outer surface of the force sensitive component 21 through an insulating adhesive 61a. The first rigid connection board 61 and the second rigid connection board 62 are spaced at a predetermined distance in the axial direction of the end cap 1.

The force sensitive component 21 has a blind hole 201 communicated with the fluid path 202 of the pressure joint 22. The bottom wall 21a of the blind hole 201 forms a membrane capable of elastic deformation, and the strain gauges are attached to the outer surface of the bottom wall 21a of the blind hole 201 for detecting the strain of the bottom wall 21a of the blind hole 201. When the pressure joint 22 is connected to the detected pipeline, the bottom wall 21a of blind hole 201 will undergo elastic deformation under the fluid pressure of the detected pipeline.

The force sensitive component 21 and the pressure joint 22 are formed as a single component. However, the present invention is not limited to the illustrated embodiments. For example, in another exemplary embodiment of the present invention, the force sensitive component 21 and the pressure joint 22 may be two independent components formed separately and welded together.

In an exemplary embodiment of the present invention, the end cap 1, the force sensitive component 21, and the pressure joint 22 may be made of stainless steel, and the seat 30 and the pin 31 of the electrical connector 3 may be made of Kovar alloy.

The pressure detection module further includes a threaded sleeve 23, which is sleeved on the other end of the pressure joint 22 and formed with an external thread 23a for threaded connection with the connection end of the detected pipeline to connect the pressure joint 22 to the detected pipeline.

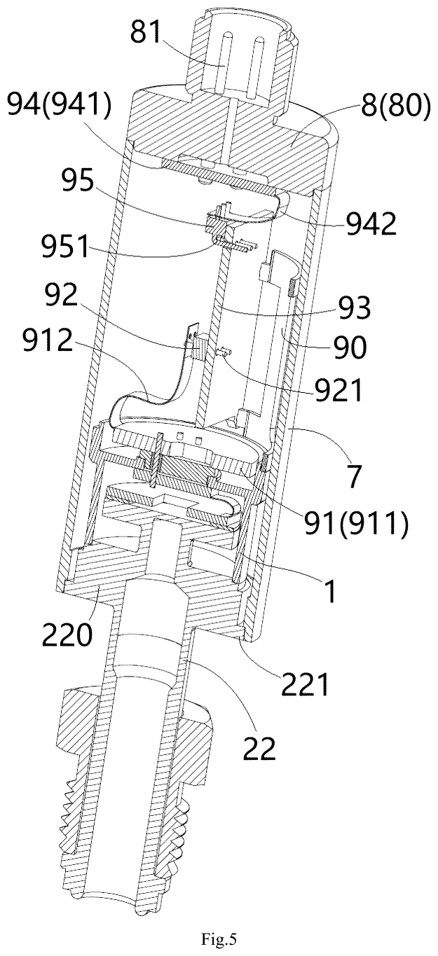

FIG. 5 shows an illustrative perspective view of a pressure sensor according to an exemplary embodiment of the present disclosure. As shown in FIGS. 1 to 5, the pressure sensor includes a housing 7 and the aforementioned pressure detection module. The pressure detection module is partially installed in the housing 7. The end cap 1 of the pressure detection module and one end 220 of the pressure joint 22 are accommodated in the housing 7, and the other end of the pressure joint 22 is located outside the housing 7 for connecting to the detected pipeline.

The housing 7 has a first port and a second port that are axially opposite to each other, and the end cap 1 and one end 220 of pressure joint 22 is inserted into the first port of the housing 7. A welding flange 221 is formed on the outer surface of one end 220 of the pressure joint 22, and the outer surface of the welding flange 221 is welded to the inner surface of the first port of the housing 7.

The pressure sensor further comprises a functional circuit board 93 and an external connector 8. The functional circuit board 93 is accommodated in the housing 7 and is electrically connected to the pins 31 of the electrical connector 3 for processing the collected pressure signal. The external connector 8 is installed on the second port of the housing 7 and electrically connected to functional circuit board 93 for outputting processed pressure signals.

The external connector 8 comprises a body 80 and a terminal 81. The body 80 is installed on the second port of the housing 7. The terminal 81 is provided in the body 80 and is electrically connected to the functional circuit board 93.

The pressure sensor further comprises a first adapter circuit board 91 and a second adapter circuit board 94. The first adapter circuit board 91 is used to connect the pin 31 of electrical connector 3 to the functional circuit board 93. The second adapter circuit board 94 is used to electrically connect the terminal 81 of external connector 8 to the functional circuit board 93.

The first adapter circuit board 91 comprises a first rigid circuit board 911 and a first flexible circuit board 912. The first rigid circuit board 911 is electrically connected to the pin 31 of electrical connector 3. The first flexible circuit board 912 is electrically connected between the first rigid circuit board 911 and the functional circuit board 93.

The second adapter circuit board 94 comprises a second rigid circuit board 941 and a second flexible circuit board 942. The second rigid circuit board 941 is electrically connected to the terminal 81 of external connector 8. The second flexible circuit board 942 is electrically connected between the second rigid circuit board 941 and the functional circuit board 93.

In the illustrated embodiments, the pressure sensor further comprises a first adapter connector 92 and a second adapter connector 95. The first adapter connector 92 has a first connection terminal 921 that is electrically connected to the first flexible circuit board 912 and the functional circuit board 93. The second adapter connector 95 has a second connection terminal 951 that is electrically connected to the second flexible circuit board 942 and the functional circuit board 93.

The pressure sensor further comprises a support frame 90, which is fixed to the end cap 1 for installing and maintaining the functional circuit board 93.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A pressure detection module, comprising:
a pressure joint adapted to connect to a detected pipeline and having a fluid path adapted for fluid communication with the detected pipeline;
a force sensitive component connected to one end of the pressure joint and in fluid communication with the pressure joint;
an electrical connector having a seat, and a pin that passes through and is fixed to the seat;
an electrical connection board adapted to electrically connect the pin to a strain gauge attached to a surface of the force sensitive component; and
an end cap including:
a peripheral wall;
an end wall;
an opening opposite to the end wall, the force sensitive component and the electrical connection board are accommodated in an inner cavity of the end cap, and one end of the pressure joint is welded to an open end of the end cap to seal the opening of the end cap; and
a socket formed in the end wall of the end cap, the seat is inserted into the socket and welded to the end wall to seal the socket of the end cap.

2. The pressure detection module according to claim 1, wherein a through-hole is formed in the seat and receives the pin therethrough, and the pin passes through the through-hole and is bonded to the seat such that the outer peripheral surface of the pin and the inner peripheral surface of the through-hole are sealed together with sintered glass.

3. The pressure detection module according to claim 2, wherein:
the seat and the pin are made of the same metal material or of metal materials with the same or similar coefficient of thermal expansion; and
the thermal expansion coefficient of the seat and the pin are the same or similar to that of the glass.

4. The pressure detection module according to claim 2, wherein the seat and the pin are made of Kovar alloy.

5. The pressure detection module according to claim 2, wherein a coating is electroplated on the exposed surface of the seat and the pin, when electroplating the coating, the electrical connector is completely immersed in the electroplating solution to simultaneously form the coating on the exposed surfaces of the seat and the pin.

6. The pressure detection module according to claim 1, wherein an annular protrusion surrounding the socket is formed on the outer side of the end wall of the end cap, and an annular flange is formed on the outer peripheral surface of the seat, the annular flange of the seat is axially pressed against the top surface of the annular protrusion of the end cap and welded to the top surface of the annular protrusion to seal the socket of the end cap.

7. The pressure detection module according to claim 1, wherein the electrical connection board includes:
a first rigid connection board attached to an outer surface of the force sensitive component and adapted to electrically connect to the strain gauge;
a second rigid connection board electrically connected to the pin of the electrical connector; and
a flexible connection board electrically connected between the first rigid connection board and the second rigid connection board.

8. The pressure detection module according to claim 7, wherein:
the first rigid connection board is adhered to the outer surface of the force sensitive component through an insulating adhesive; and
the first rigid connection board and the second rigid connection board are spaced at a predetermined distance in an axial direction of the end cap.

9. The pressure detection module according to claim 1, wherein the force sensitive component includes a blind hole communicated with the fluid path of the pressure joint, and a bottom wall of the blind hole forms a membrane capable of elastic deformation, the strain gauge is attached to the outer surface of the bottom wall of the blind hole and adapted to detect strain on the bottom wall of the blind hole.

10. The pressure detection module according to claim 1, wherein:
the force sensitive component and the pressure joint are formed into a single integral component; or
the force sensitive component and the pressure joint are two independent components formed separately and welded together.

11. The pressure detection module according to claim 1, wherein the end cap, the force sensitive component, and the pressure joint are made of stainless steel, and the seat and pin of the electrical connector are made of Kovar alloy.

12. The pressure detection module according to claim 1, further comprising a threaded sleeve fitted on the other end of the pressure joint and formed with an external thread for threaded connection with a connection end of the detected pipeline and adapted to connect the pressure joint to the detected pipeline.

13. A pressure sensor, comprising:
a housing; and
a pressure detection module partially installed in the housing, including:
a pressure joint adapted to connect to a detected pipeline and having a fluid path adapted for fluid communication with the detected pipeline;
a force sensitive component connected to one end of the pressure joint and in fluid communication with the pressure joint;
an electrical connector having a seat and a pin passing through and fixed to the seat;
an electrical connection board adapted to electrically connect the pin to a strain gauge attached to the surface of the force sensitive component; and
an end cap including a peripheral wall, an end wall, and an opening opposite to the end wall, the force sensitive component and the electrical connection board are accommodated in an inner cavity of the end cap, and one end of the pressure joint is welded to an open end of the end cap to seal the opening of the end cap, wherein a socket is formed in the end wall of the end cap, and the seat is inserted into the socket and welded to the end wall to seal the socket of the end cap, the end cap and one end of the pressure joint are accommodated in the housing, and the other end of the pressure joint is located outside the housing for connection to the detected pipeline.

14. The pressure sensor according to claim 13, wherein:
the housing has a first port and a second port that are axially opposite, and the end cap and one end of the pressure joint are inserted into the first port of the housing; and
a welding flange is formed on the outer surface of one end of the pressure joint, an outer surface of the welding flange is welded to an inner surface of the first port of the housing.

15. The pressure sensor according to claim 14, further comprising:
a functional circuit board accommodated in the housing and electrically connected to the pin of the electrical connector; and
an external connector installed on the second port of the housing and electrically connected to the functional circuit board.

16. The pressure sensor according to claim 15, wherein the external connector includes:
a body installed on the second port of the housing; and
a terminal provided in the body and electrically connected to the functional circuit board.

17. The pressure sensor according to claim 15, further comprising:
a first adapter circuit board electrically connecting the pin of the electrical connector to the functional circuit board; and
a second adapter circuit board electrically connecting the terminal of the external connector to the functional circuit board.

18. The pressure sensor according to claim 17, wherein:
the first adapter circuit board includes:
a first rigid circuit board electrically connected to the pin of the electrical connector; and
a first flexible circuit board electrically connected between the first rigid circuit board and the functional circuit board; and
the second adapter circuit board includes:
a second rigid circuit board electrically connected to the terminal of the external connector; and
a second flexible circuit board electrically connected between the second rigid circuit board and the functional circuit board.

19. The pressure sensor according to claim 18, further comprising:
a first adapter connector having a first connection terminal electrically connected to the first flexible circuit board and the functional circuit board; and
a second adapter connector having a second connection terminal electrically connected to the second flexible circuit board and the functional circuit board.

20. The pressure sensor according to claim 15, further comprising a support frame fixed to the end cap and supporting the functional circuit board.
